(19) United States
(12) Patent Application Publication
(10) Pub. No.: US 2010/0190064 A1
(43) Pub. Date: Jul. 29, 2010

(54) NONAQUEOUS ELECTROLYTE SECONDARY BATTERY

(75) Inventors: Yoshihiko Ikeda, Itano-gun (JP); Takuya Morimoto, Itano-gun (JP); Hideyuki Inomata, Itano-gun (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/690,981

(22) Filed: Jan. 21, 2010

(30) Foreign Application Priority Data
Jan. 28, 2009 (JP) 2009-017348

(51) Int. Cl. H01M 6/16

(52) U.S. Cl. 429/330

(57) ABSTRACT

The nonaqueous electrolyte secondary battery uses a positive electrode active material which is a mixture of large particle diameter-positive electrode active material particles having a central particle diameter D₅₀ of 15 to 30 μm and small particle diameter-positive electrode active material particles having a central particle diameter D₅₀ of 1 to 8 μm, in which the particle size distribution has a peak having a relative particle amount of 5% or more in each of a particle diameter range of 15 to 30 μm and a particle diameter range of 1 to 8 μm, and the nonaqueous electrolyte contains 1,3-dioxane, a vinylene carbonate compound, and at least one type of aromatic compound selected from a cycloalkylbenzene compound and a compound having a quaternary carbon adjacent to a benzene ring, thus having high safety when overcharged, a large initial capacity and excellent charging-discharging cycle characteristics and generating less gas.

### TECHNICAL FIELD

The present invention relates to a nonaqueous electrolyte secondary battery. More particularly, the invention relates to a nonaqueous electrolyte secondary battery having high safety when overcharged, a large initial capacity and excellent charging-discharging cycle characteristics, and generating only a small amount of a gas by using plural types of positive electrode active materials having particle diameter distributions different from each other and by adding a specific additive into the nonaqueous electrolyte.

### BACKGROUND ART

As a driving power source for recent portable electronic equipment such as a portable phone, a portable personal computer and a portable music player and further, as a power source for hybrid electric vehicles (HEV) and electric vehicles (EV), a nonaqueous electrolyte secondary battery represented by a lithium ion secondary battery and having a high energy density and a high capacity is widely utilized. Among them, a nonaqueous electrolyte secondary battery using graphite particles as a negative electrode active material has high safety and a high capacity, and is thus widely used.

As a positive electrode active material of these nonaqueous electrolyte secondary batteries, lithium transition-metal composite oxides capable of reversibly intercalating and deintercalating lithium ions such as LiCoO₂, LiNiO₂, LiNiₓCo₁₋ₓO₂ (x=0.01 to 0.99), LiMnO₂, LiMn₂O₄, LiCoₓMn_{y}Ni_{z}O₂ (x+y+z=1) or LiFePO₄ are used individually or in a mixture of two or more types thereof.

Among these positive electrode active materials, because of having various battery characteristics particularly superior to those of other positive electrode active materials, lithium-cobalt composite oxide or dissimilar metal element-added lithium-cobalt composite oxide is frequently used. However, cobalt is expensive and the amount of cobalt in natural resources is small. Therefore, in order to use continuously these lithium-cobalt composite oxide or dissimilar metal element-added lithium-cobalt composite oxide as a positive electrode active material of the nonaqueous electrolyte secondary batteries, it is desired that the nonaqueous electrolyte secondary batteries have higher-performance. For achieving a nonaqueous electrolyte secondary battery using such a lithium-cobalt composite oxide as the positive electrode active material and having higher-performance and longer-life-time, the capacity and the safety of the battery must be enhanced.

As an invention for solving such a problem, JP-A-9-306546 discloses an invention of a positive electrode for a nonaqueous electrolyte secondary battery for enlarging the battery capacity by using two types of lithium cobalt oxides having average particle diameters different from each other to make high-density packing of the positive electrode possible. In addition, JP-A-2008-277086 discloses a nonaqueous electrolyte secondary battery having advantageous high-temperature preservation characteristics and excellent safety when overcharged by using a positive electrode active material containing lithium cobalt oxide containing at least one type of magnesium and zirconium and by adding 1,3-dioxane, a vinylene carbonate compound and at least one type of aromatic compound selected from a cycloalkylbenzene compound and a compound having a quaternary carbon adjacent to a benzene ring into a nonaqueous electrolyte.

In a nonaqueous electrolyte secondary battery using a positive electrode packed to a high density using two types of positive electrode active materials having average particle diameters different from each other as disclosed in JP-A-9-306546, due to the existence of a positive electrode active material having a small average particle diameter, the surface area of the whole positive electrode active material becomes large, the reactivity of the positive electrode active material with an additive in the nonaqueous electrolyte becomes high. As a result, a gas is generated and a battery case may be swollen, so that there a further countermeasure for securing the safety of the battery in a scene where the battery is not appropriately used is necessary.

The present inventors have made extensive and intensive experiments for solving problems when a positive electrode packed to a high density using the above-described two types of positive electrode active materials having average particle diameters different from each other. As a result, the inventors have found that by combining a positive electrode packed to a high density using two types of positive electrode active materials having average particle diameters different from each other with a nonaqueous electrolyte disclosed in JP-A-2008-277086, there can be obtained a nonaqueous electrolyte secondary battery having not only excellent safety when overcharged, but also a large initial capacity and advantageous charging-discharging cycle properties, and generating only a small amount of a gas, so that the variance in the thickness of the battery is small. Based on this discovery, the invention is completed.

### SUMMARY

An advantage of some aspects of the invention is to provide a nonaqueous electrolyte secondary battery using a positive electrode packed to a high density using two types of positive electrode active materials having average particle diameters different from each other, which has high safety when overcharged, a large initial capacity and excellent charging-discharging cycle characteristics and generates only a small amount of a gas.

For achieving the above-described advantage, the nonaqueous electrolyte secondary battery of the present invention is a nonaqueous electrolyte secondary battery containing a positive electrode having a positive electrode active material, a negative electrode, and a nonaqueous electrolyte having a nonaqueous solvent and an electrolyte salt, in which: the positive electrode active material is a mixture of large particle diameter-positive electrode active material particles having a central particle diameter in a number average particle diameter distribution D₅₀ of 15 to 30 μm and small particle diameter-positive electrode active material particles having a central particle diameter in a number average particle diameter distribution D₅₀ of 1 to 8 μm, in which the particle size distribution has a peak having a relative particle amount of 5% or more in each of a particle diameter range of 15 to 30 μm and a particle diameter range of 1 to 8 μm; and the nonaqueous electrolyte contains 1,3-dioxane, a vinylene carbonate compound, and at least one type of aromatic compound selected from a cycloalkylbenzene compound and a compound having a quaternary carbon adjacent to a benzene ring.

In the invention, as the positive electrode active material, there is used a mixture of large particle diameter-positive electrode active material particles having a central particle diameter in a number average particle diameter distribution D₅₀ of 15 to 30 μm and small particle diameter-positive electrode active material particles having a central particle diameter in a number average particle diameter distribution D₅₀ of 1 to 8 μm, in which the particle size distribution has a peak having a relative particle amount of 5% or more in each of a particle diameter range of 15 to 30 μm and a particle diameter range of 1 to 8 μm. By using a mixture of large particle diameter-positive electrode active material particles and small particle diameter-positive electrode active material particles as the positive electrode active material, as disclosed in JP-A-9-306546, the packing density of the positive electrode active material becomes possible to be easily enlarged. At this time, by using positive electrode active material particles in which the particle size distribution has a peak having a relative particle amount of 5% or more in each of a particle diameter range of 15 to 30 μm and a particle diameter range of 1 to 8 μm, a variation of the particle diameter in each of particle diameter ranges becomes small, so that the effect of enhancing the packing density of the positive electrode active material becomes larger.

In addition, the nonaqueous electrolyte secondary battery of the invention contains as an additive in the nonaqueous electrolyte, 1,3-dioxane, a vinylene carbonate compound, and at least one type of aromatic compound selected from a cycloalkylbenzene compound and a compound having a quaternary carbon adjacent to a benzene ring. It is known that from a nonaqueous electrolyte containing such an additive, as disclosed in JP-A-2008-277086, a nonaqueous electrolyte secondary battery having advantageous high-temperature storage characteristics and excellent safety when overcharged can be obtained. However, in the invention, by combining the nonaqueous electrolyte having the above additive with a mixture of large particle diameter-positive electrode active material particles and small particle diameter-positive electrode active material particles in which the particle size distribution has a peak having a relative particle amount of 5% or more in each of a particle diameter range of 15 to 30 μm and a particle diameter range of 1 to 8 μm as the positive electrode active material, there can be worked such an excellent effect unpredictable from the related art as capable of obtaining a nonaqueous electrolyte secondary battery having not only excellent safety when overcharged and a large initial capacity, but also advantageous charging-discharging cycle properties, and generating only a small amount of a gas, so that the variance in the thickness of the battery is small.

It is considered that reasons for that in the nonaqueous electrolyte secondary battery of the invention, the above-described effect of having excellent safety when overcharged is worked, are:

(1) by preparing the positive electrode active material as a mixture of large particle diameter-positive electrode active material particles and small particle diameter-positive electrode active material particles, the surface area per unit volume of the positive electrode active material is enlarged, so that the reaction of the positive electrode active material with a vinylene carbonate compound, at least one type of aromatic compound selected from a cycloalkylbenzene compound and a compound having a quaternary carbon adjacent to a benzene ring, or 1,3-dioxane is accelerated, and
(2) first, during the initial charging, 1,3-dioxane is decomposed in the positive electrode side to form a stable protective coating film on the surface of the positive electrode and consequently, the decomposition of cycloalkylbenzene compound and a compound having a quaternary carbon adjacent to a benzene ring are suppressed, so that a satisfactory amount of a cycloalkylbenzene compound and a compound having a quaternary carbon adjacent to a benzene ring are remained and consequently, the effect of suppressing a thermal runaway in an overcharged state is enlarged.

Here, the vinylene carbonate compound is idiomatically used in the related art as an additive for suppressing a reductive decomposition of an organic solvent and by addition of the vinylene carbonate compound, before insertion of lithium into the negative electrode by the first charging, a negative electrode surface film (solid electrolyte interface (SEI)) also referred to as a passivation layer is formed on a layer of the negative electrode active material. Since the SEI film functions as a barrier to inhibit insertion of solvent molecules around lithium ions, the negative electrode active material becomes not directly reacted with the organic solvent. In the invention, a negative electrode protecting effect of the vinylene carbonate compound, a positive electrode protecting effect of 1,3-dioxane and a thermal runaway suppressing effect of a cycloalkyl benzene compound or an aromatic compound having a quaternary carbon adjacent to a benzene ring are synergistically worked, so that a nonaqueous electrolyte secondary battery having high safety when overcharged, a large initial capacity and excellent charging-discharging cycle properties and generating only a small amount of a gas becomes obtained.

In addition, examples of the cycloalkylbenzene compound capable of being used in the invention include cyclopentylbenzene, cyclohexylbenzene, cycloheptylbenzene and methylcyclohexylbenzene. Among them, cyclohexylbenzene having high thermal-runaway suppressing effect is preferably used.

In addition, examples of the compound having a quaternary carbon adjacent to a benzene ring capable of being used in the invention include tert-amylbenzene, tert-butylbenzene and tert-hexylbenzene. Among them, tert-amylbenzene having high thermal-runaway suppressing effect is preferably used. Here, in the nonaqueous electrolyte secondary battery of the invention, the content ratio between the cycloalkylbenzene compound and the compound having a quaternary carbon adjacent to a benzene ring is arbitral.

Examples of the vinylene carbonate compound capable of being used in the invention include vinylene carbonate, methylvinylene carbonate, ethylvinylene carbonate, dimethylvinylene carbonate, ethylmethylvinylene carbonate, diethylvinylene carbonate and propylvinylene carbonate. Among them, vinylene carbonate has a large effect of suppressing the reductive decomposition of an organic solvent per a unit mass, so that is particularly preferred.

As the positive electrode active material used in the nonaqueous electrolyte secondary battery of the invention, as described above, lithium transition-metal composite oxides capable of reversibly intercalating and deintercalating lithium ions such as LiCoO₂, LiNiO₂, LiNiₓCo₁₋ₓO₂ (x=0.01 to 0.99), LiMnO₂, LiMn₂O₄, LiCoₓMn_{y}Ni_{z}O₂ (x+y+z=1) or LiFePO₄ can be used individually or in a mixture of two or more types thereof. Further, a lithium-cobalt composite oxide to which dissimilar metal elements such as zirconium and magnesium are added can be also used.

In addition, as a nonaqueous solvent (organic solvent) constituting the nonaqueous electrolyte used in the nonaqueous electrolyte secondary battery of the invention, carbonates, lactones, ethers, esters, or the like can be used, and a mixture of two or more types of these solvents can also be used. Among them, particularly preferred is a mixture of a cyclic carbonate and a chain carbonate to be used.

Specific examples thereof include ethylene carbonate (EC), propylene carbonate (PC), butylene carbonate (BC), cyclopentanone, sulfolane, 3-methylsulfolane, 2,4-dimethylsulfolane, 3-methyl-1,3-oxazolidine-2-one, dimethyl carbonate (DMC), methyl ethyl carbonate (MEC), diethyl carbonate (DEC), methyl propyl carbonate, methyl butyl carbonate, ethyl propyl carbonate, ethyl butyl carbonate, dipropyl carbonate, γ-butyrolactone, γ-valerolactone, 1,2-dimethoxyethane, tetrahydrofuran, 2-methyltetrahydrofuran, 1,3-dioxolane, methyl acetate, ethyl acetate and 1,4-dioxane.

As a solute of the nonaqueous electrolyte in the invention, lithium salts generally used as the solute in the nonaqueous electrolyte secondary battery can be used. Examples of such lithium salts include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂ and mixtures thereof. Among them, LiPF₆ (lithium hexafluoro phosphate) is preferred to be used. It is preferred that the amount of a dissolved solute in the nonaqueous solvent is 0.5 to 2.0 mol/L.

In addition, in the nonaqueous electrolyte secondary battery of the invention, it is preferred that in the positive electrode active material, small particle diameter-positive electrode active material particles are blended in a content of 10% by mass or more and 50% by mass or less, based on the mass of the whole positive electrode active material.

Even when the content of the small particle diameter-positive electrode active material is a trace amount, some effect of enhancing the safety in it's own way can be obtained, however, when it is less than 10% by mass based on the mass of the whole positive electrode active material, the effect of enhancing the packing density of the positive electrode active material is small and moreover, the effect of enhancing the safety by adding the small particle diameter-positive electrode active material is small. In contrast, when the content of the small particle diameter-positive electrode active material is more than 50% by mass based on the mass of the whole positive electrode active material, though the packing density is enhanced, the reactivity of the small particle diameter-positive electrode active material with an additive in the nonaqueous electrolyte starts to become higher, which is not preferred.

In addition, in the nonaqueous electrolyte secondary battery of the invention, it is preferred that: the content of the 1,3-dioxane is 0.5% by mass or more and 3.0% by mass or less; the content of the vinylene carbonate compound is 0.5% by mass or more and 5.0% by mass or less as vinylene carbonate; and the content of the aromatic compound is 0.5% by mass or more and 3.0% by mass or less as at least one type of aromatic compound selected from cyclohexylbenzene and tert-amylbenzene, each based on the mass of the whole nonaqueous electrolyte.

Even when additive amounts of 1,3-dioxane, a vinylene carbonate compound and at least one type of aromatic compound selected from a cycloalkylbenzene compound and a compound having a quaternary carbon adjacent to a benzene ring are a trace amount, some effect in it's own way is worked. However, when the lower limit value of the additive amount of 1,3-dioxane is less than 0.5% by mass based on the mass of the whole nonaqueous electrolyte, the lower the additive amount is, the lower the safety when overcharged is, so that it is preferably 0.5% by mass or more. In contrast, when the upper limit value of the additive amount of 1,3-dioxane is more than 3.0% by mass based on the mass of the whole nonaqueous electrolyte, the higher the additive amount is, the lower the initial capacity is and the more the charging-discharging cycle properties are impaired due to an excessive formation of a positive electrode protecting film and further, the larger the variance in the thickness of the battery is, so that it is preferably 3.0% by mass or less.

When the lower limit value of the additive amount of the vinylene carbonate compound is less than 0.5% by mass as vinylene carbonate based on the mass of the whole nonaqueous electrolyte, the lower the additive amount is, the lower the safety when overcharged becomes, so that it is preferably 0.5% by mass or more. In contrast, when the upper limit value of the additive amount of the vinylene carbonate compound is more than 5.0% by mass based on the mass of the whole nonaqueous electrolyte, the initial capacity starts to be lowered, so that it is preferably 5.0% by mass or less. The lower limit value of the additive amount of the vinylene carbonate compound is more preferably 0.5% by mass or more and 4% by mass or less as vinylene carbonate based on the mass of the whole nonaqueous electrolyte.

In addition, when the lower limit value of the additive amount of at least one type of aromatic compound selected from a cycloalkylbenzene compound and a compound having a quaternary carbon adjacent to a benzene ring is less than 0.5% by mass as at least one type of aromatic compound selected from cycloalkylbenzene and tert-amylbenzene based on the mass of the whole nonaqueous electrolyte, the lower the additive amount is, the lower the safety when overcharged is, so that it is preferably 0.5% by mass or more. In contrast, when the upper limit value of the additive amount of the aromatic compound is more than 3.0% by mass based on the mass of the whole nonaqueous electrolyte, the charging-discharging cycle properties are impaired and further, the variance in the thickness of the battery becomes larger, so that it is preferably 3.0% by mass or less.

### DESCRIPTION OF EXEMPLARY EMBODIMENTS

Hereinafter, exemplary embodiments of the invention will be described in detail with Examples and Comparative Examples. However, the examples described below are an illustrative example of nonaqueous electrolyte secondary batteries for embodying the technical spirit of the invention, are not intended to limit the invention to the examples, and may be equally applied to various modified batteries without departing from the technical spirit described in the Claims.

### Examples

Preparation of Positive Electrode Active Material

First, the specific production method of the nonaqueous electrolyte secondary battery common to Examples and Comparative Examples, is described. As the positive electrode active material, cobalt lithium oxide containing zirconium (Zr) and magnesium (Mg) (LiCoO₂ containing Zr and Mg) was used. This LiCoO₂ containing Zr and Mg was prepared as follows. First, as the starting raw material, lithium carbonate (Li₂CO₃) as a lithium source was used. As a cobalt source, there was used tricobalt tetraoxide containing zirconium and magnesium (Co₃O₄ containing Zr and Mg) obtained by a method including: dissolving zirconium and magnesium in a cobalt acid aqueous solution so that the concentrations of zirconium and magnesium become 0.15 mol % and 0.5 mol %, respectively, based on the mol of cobalt; adding a sodium carbonate aqueous solution to the resultant acid aqueous solution to co-precipitate CoCO₃ containing Zr and Mg; and subjecting the co-precipitated compound to a thermal decomposition in an air atmosphere.

Next, the Co₃O₄ containing Zr and Mg and lithium carbonate were weighed in a predetermined amount and were mixed, and then the resultant mixture was calcined at 850° C. in an air atmosphere for 24 hours to obtain LiCoO₂ containing Zr and Mg. The obtained LiCoO₂ containing Zr and Mg was ground in a mortar to prepare a positive electrode active material A having an average particle diameter of 17 μm and a positive electrode active material B having an average particle diameter of 6 μm. Here, the average particle diameter of the positive electrode active materials A, B was measured using a laser refraction-type particle size distribution measuring apparatus (trade name: SALD-200J; manufactured by Shimadzu Corporation). A particle diameter by which a cumulative particle amount (number) based on the particle diameter in the results of the above measurement becomes 50% was measured as an average particle diameter. In addition, in the measurement, water was used as a dispersion medium.

The thus obtained positive electrode active materials A, B were mixed in a predetermined mass ratio to obtain a positive electrode active material C.

Preparation of Positive Electrode

Next, the positive electrode active material C, carbon powder as a conductive material and polyvinylidene fluoride powder as a binder were mixed so that each component of the resultant mixture has a content of 94% by mass, 3.0% by mass and 3.0% by mass, respectively, and the resultant mixture was mixed with a solvent of N-methylpyrrolidone (NMP) to prepare a slurry. The slurry was applied on both sides of a positive electrode collector composed of an aluminum foil with a thickness of 15 μm by a doctor blade method and was dried to form active material layers on both sides of the positive electrode collector. Thereafter, the collector was compressed with a compression roller and was cut out in a predetermined size to prepare positive electrode plates used in Examples 1 to 12 and Comparative Examples 1 to 8.

Preparation of Negative Electrode

95.0% by mass of graphite powder as a negative electrode active material, 3.0% by mass of carboxymethylcellulose (CMC) as a thickener and 2% by mass of styrene-butadiene rubber (SBR) as a binder were dispersed in water to prepare a slurry. The slurry was applied on both sides of a negative electrode collector composed of a copper foil having a thickness of 8 μm by doctor blade method and then was dried to form active material layers on both sides of the negative electrode collector. Thereafter, the collector was compressed with a compression roller and was cut out in a predetermined size to prepare negative electrode plates commonly used in Examples 1 to 12 and Comparative Examples 1 to 8. Here, the applied amounts of the positive and negative electrode active materials were controlled so that at 4.2 V of a cell charging voltage which is the design standard (positive electrode charging potential is 4.3 V based on lithium), the charging capacity ratio of the positive and negative electrodes (negative electrode charging capacity/positive electrode charging capacity) at a part of the positive electrode and a part of the negative electrode which are opposite to each other becomes 1.1.

Preparation of Rolled Electrode

The above-prepared positive electrode plate and negative electrode plate were rolled together with a separator composed of a polyethylene-made microporous membrane interposed between the positive and negative electrode plates and then the resultant rolled electrode was crushed to prepare a flat-shaped rolled electrode.

Preparation of Nonaqueous Electrolyte

As the nonaqueous electrolyte, nonaqueous electrolytes used in Examples 1 to 12 and Comparative Examples 1 to 8 were prepared by a method including: mixing ethylene carbonate, methylethyl carbonate and diethyl carbonate so that the mixing ratio becomes 30:60:10 (in volume ratio at 25° C.) to prepare a solvent mixture; dissolving hexafluoro lithium phosphate (LiPF₆) in the resultant solvent mixture so that the concentration of LiPF₆ becomes 1 mol/L; and adding 1,3-dioxane (DOX), vinylene carbonate (VC), cyclohexylbenzene (CHB) and tert-amylbenzene (TAB) each in a predetermined amount to the resultant solution.

Production of Battery

The above electrode was inserted into an aluminum-made outer can molded beforehand into a cup shape (concave shape) and then an opening part of the outer can was sealed with a sealing plate on which a liquid inlet is provided. Next, the above nonaqueous electrolyte was injected through the liquid inlet and then the liquid inlet was sealed to produce a nonaqueous electrolyte secondary battery having a size of thickness 4.3 mm×width 34 mm×height 43 mm. The rated capacity of this nonaqueous electrolyte secondary battery is 750 mAh.

Overcharge Safety Test

The nonaqueous electrolyte secondary batteries of Examples 1 to 8 and Comparative Examples 1 to 5 produced as described above were overcharged with a predetermined current until the battery voltage became 12.0 V. An overcharge test 1 was performed using a current of 0.6 It (450 mA); an overcharge test 2 was performed using a current of 0.8 It (600 mA); and an overcharge test 3 was performed using a current of 1.0 It (750 mA). As the result of the overcharge test, a battery in which neither smoking nor liquid leak was caused was evaluated with “A” and a battery in which at least any one of smoking and liquid leak was caused was evaluated with “B”. The result is summarized in Table 1.

TABLE 1

| | Ratio of positive | | | | | | | |
|---|---|---|---|---|---|---|---|---|
| | electrode active | Additive amount | | | | | | |
| | material B | (% by mass) | | | | Overcharge | Overcharge | Overcharge |
| | (% by mass) | DOX | VC | CHB | TAB | test 1 | test 2 | test 3 |
| Example 1 | 10 | 2 | 2 | 2 | 0 | A | A | A |
| Example 2 | 10 | 0.5 | 2 | 2 | 0 | A | A | A |
| Example 3 | 10 | 2 | 2 | 0.5 | 0 | A | A | A |
| Example 4 | 10 | 2 | 0.5 | 2 | 0 | A | A | A |
| Example 5 | 10 | 0.5 | 2 | 0.5 | 0 | A | A | A |
| Example 6 | 10 | 2 | 2 | 0 | 0.5 | A | A | A |
| Example 7 | 30 | 2 | 2 | 2 | 0 | A | A | A |
| Example 8 | 50 | 2 | 2 | 2 | 0 | A | A | A |
| Comparative | | | | | | | | |
| Example 1 | 0 | 0 | 2 | 2 | 0 | A | B | B |
| Comparative | 10 | 0 | 2 | 2 | 0 | A | A | B |
| Example 2 | | | | | | | | |
| Comparative | | | | | | | | |
| Example 3 | 0 | 1 | 2 | 2 | 0 | A | B | B |
| Comparative | | | | | | | | |
| Example 4 | 10 | 2 | 2 | 0 | 0 | A | A | B |
| Comparative | | | | | | | | |
| Example 5 | 10 | 2 | 0 | 2 | 0 | A | A | B |

From the result shown in Table 1, the followings are apparent. First, from the results of Comparative Examples, it is apparent that when at least two types of DOX, VC and CHB are added in the nonaqueous electrolyte and small particle diameter-positive electrode active material particles (average particle diameter: 6 μm) are added in the positive electrode active material, the safety when overcharged is enhanced to some extent. On the other hand, from the results of Comparative Example 2 and Examples 1 and 2, it is apparent that small particle diameter-positive electrode active material particles are added in the positive electrode active material and not only VC and CHB, but also DOX are added in the nonaqueous electrolyte, the effect of enhancing the safety when overcharged becomes more remarkable.

Further, from the results of Comparative Examples 1 and 3 and Examples 1 and 2, it is apparent that the effect of enhancing the safety is not an effect generated by simply totaling an effect due to the existence of small particle diameter-positive electrode active material in the positive electrode active material and an effect due to the existence of DOX in the nonaqueous electrolyte, but an effect exhibited synergistically by both the existence of small particle diameter-positive electrode active material particles in the positive electrode active material and the existence of DOX in the nonaqueous electrolyte. In other words, from the results of Comparative Examples 1 and 3, only by adding DOX, the effect of enhancing the safety is not exhibited, and from the result of Example 2 in which small particle diameter-positive electrode active material particles exist in the positive electrode active material, even with an additive amount of DOX smaller than that in Comparative Example 3, when it is in the presence of small particle diameter-positive electrode active material particles, a remarkable effect of enhancing the safety is exhibited.

In addition, from the results of Example 1, Example 7 and Example 8, it is apparent that the content of small particle diameter-positive electrode active material particles is most preferably 10% by mass or more and 50% by mass or less. However, when small particle diameter-positive electrode active material particles are blended in the positive electrode active material even in a slight blending ratio, some effect of enhancing the safety in it's own way can be obtained. When the blending ratio is too small, the packing density of the positive electrode active material is not increased. In contrast, when the blending ratio is more than 50% by mass, though the packing density of the positive electrode active material is increased, the reactivity of small particle diameter-positive electrode active material with an additive in the nonaqueous electrolyte becomes excessively high, so that the effect of enhancing the safety is gradually lowered.

In addition, from the results of Examples 3 and 6, it is apparent that when at least any one of CHB and TAB is added in the nonaqueous electrolyte, the effect of enhancing the safety is exhibited. Then, when comparing the results of Comparative Examples 2, 4 and 5 with the results of Examples 2 to 6, it is apparent that when DOX, VC and further CHB or TAB are added, an advantageous effect of enhancing the safety can be achieved, and a more preferred additive amount of each component in the nonaqueous electrolyte is 0.5% by mass or more.

Charging-Discharging Test

Next, each five pieces of nonaqueous electrolyte secondary batteries of Examples 1 and 9 to 12 and Comparative Examples 1, 2 and 6 to 8 produced as described above were subjected to the charging-discharging test in a thermostat of 25° C. and the measurement result was obtained as an average value of each five pieces. At this time, the charging-discharging conditions were as follows. First, the first charging of the batteries was performed with a constant current of 1 It (750 mA) until the battery voltage reached 4.2 V and after the battery voltage reached 4.2 V, the second charging of the batteries was performed with a constant voltage of 4.2 V until the current value reached 1/50 It (15 mA). Next, the discharging of the batteries was performed with a constant current of 1 It (750 mA) until the battery voltage reached 2.75 V and a set of the above first and second chargings and this discharging were regarded as one cycle of the charging-discharging to measure a discharging capacity of the first cycle as the initial capacity. Thereafter, 500 cycles of the charging-discharging were performed and the discharging capacity of 500^{th} cycle was measured to calculate the residual ratio according to the equation:

Residual ratio (%)=(discharging capacity of 500^{th} cycle/initial capacity)×100.

The thickness of the battery after 500 cycles was also measured. The results thereof are summarized in Table 2

TABLE 2

| | Ratio of positive | | | | | | | |
|---|---|---|---|---|---|---|---|---|
| | electrode active | Additive amount | | | | Initial | After 500^{th} cycle | |
| | material B | (% by mass) | | | | capacity | Residual | Thickness |
| | (% by mass) | DOX | VC | CHB | TAB | (mAh) | rate (%) | (mm) |
| Comparative | 0 | 0 | 2 | 2 | 0 | 757 | 83 | 4.7 |
| Example 1 | | | | | | | | |
| Comparative | 10 | 0 | 2 | 2 | 0 | 754 | 84 | 4.7 |
| Example 2 | | | | | | | | |
| Example 1 | 10 | 2 | 2 | 2 | 0 | 755 | 83 | 4.8 |
| Example 9 | 10 | 2 | 2 | 3 | 0 | 755 | 81 | 4.9 |
| Example 10 | 10 | 2 | 2 | 0 | 3 | 754 | 81 | 4.9 |
| Example 11 | 10 | 2 | 4 | 2 | 0 | 750 | 82 | 4.8 |
| Example 12 | 10 | 2 | 2 | 4 | 0 | 758 | 79 | 5.4 |
| Example 13 | 10 | 2 | 6 | 2 | 0 | 730 | 80 | 4.9 |
| Example 14 | 10 | 3 | 2 | 2 | 0 | 754 | 82 | 4.9 |
| Example 15 | 10 | 4 | 2 | 2 | 0 | 734 | 78 | 5.3 |

From the results shown in Table 2, the followings are apparent. That is, when the additive (DOX, VC, CHB, TAB) is added to the nonaqueous electrolyte in an excessive amount, it affects adversely the initial capacity or the cycle characteristics. In other words, in comparison among Example 1, Example 14 and Example 15, it is apparent that according to the increase of the additive amount of DOX to the nonaqueous electrolyte from 2% by mass to 4% by mass, the lowering of the initial capacity, the lowering of the capacity residual ratio and the increase of the battery thickness become caused. Therefore, the additive amount of DOX to the nonaqueous electrolyte is preferably 4% by mass or less, more preferably 3% by mass or less, however, when considering also the result shown in Table 1 together, it is more preferably 0.5% by mass or more and 3% by mass or less.

In addition, from the results of Examples 1, 9, 10 and 12, when the additive amount of CHB or TAB to the nonaqueous electrolyte is increased from 2% by mass to 4% by mass, though the initial capacity results in an advantageous result, the capacity residual ratio starts to be lowered and the battery thickness tends to be increased. Therefore, the additive amount of CHB or TAB to the nonaqueous electrolyte is preferably 4% by mass or less, more preferably 3% by mass or less, however, when considering also the result shown in Table 1 together, it is more preferably 0.5% by mass or more and 3% by mass or less.

Further, from the results of Examples 1, 11 and 13, according to the increase of the additive amount of VC to the nonaqueous electrolyte from 2% by mass to 6% by mass, though the battery thickness results in substantially the same result, the initial capacity is lowered and also the capacity residual ratio tends to be lowered even slightly. Therefore, the additive amount of VC to the nonaqueous electrolyte is preferably 6% by mass or less, however, when employing an interpolated value, it is preferably 5% by mass or less and when considering also the result shown in Table 1 together, it is more preferably 0.5% by mass or more and 5% by mass or less. The additive amount of VC to the nonaqueous electrolyte is most preferably 0.5% by mass or more and 4% by mass or less.

What is claimed is:

1. A nonaqueous electrolyte secondary battery comprising:
a positive electrode having a positive electrode active material;
a negative electrode; and
a nonaqueous electrolyte having a nonaqueous solvent and an electrolyte salt,
the positive electrode active material being a mixture of large particle diameter-positive electrode active material particles having a central particle diameter in a number average particle diameter distribution D₅₀ of 15 to 30 μm and small particle diameter-positive electrode active material particles having a central particle diameter in a number average particle diameter distribution D₅₀ of 1 to 8 μm, in which the particle size distribution has a peak having a relative particle amount of 5% or more in each of a particle diameter range of 15 to 30 μm and a particle diameter range of 1 to 8 μm; and
the nonaqueous electrolyte containing 1,3-dioxane, a vinylene carbonate compound, and at least one type of aromatic compound selected from a cycloalkylbenzene compound and a compound having a quaternary carbon adjacent to a benzene ring.

2. The nonaqueous electrolyte secondary battery according to claim 1, wherein in the positive electrode active material, the small particle diameter-positive electrode active material particles are blended in a content of 10% by mass or more and 50% by mass or less, based on the mass of the whole positive electrode active material.

3. The nonaqueous electrolyte secondary battery according to claim 1, wherein
the content of the 1,3-dioxane is 0.5% by mass or more and 3.0% by mass or less;
the content of the vinylene carbonate compound is 0.5% by mass or more and 5.0% by mass or less as vinylene carbonate; and
the content of the aromatic compound is 0.5% by mass or more and 3.0% by mass or less as at least one type of aromatic compound selected from cyclohexylbenzene and tert-amylbenzene; each based on the mass of the whole nonaqueous electrolyte.
